(19) United States
(12) Patent Application Publication
(10) Pub. No.: US 2010/0007715 A1
(43) Pub. Date: Jan. 14, 2010

(54) Method of Shooting Angle Adjustment for an Image Capturing Device that Moves Along a Circular Path

(75) Inventors: Peng-Cheng Lai, Los Altos, CA (US); Liang-An Chang, Yuanlin Township (TW); Chih-Chuan Kao, Yonghe City (TW); Tsang-En Chang, Sindian City (TW); Kuo-Hsin Yeh, Hukou Township (TW)

Correspondence Address: Cooper Legal Group LLC, 6505 Rockside Road, Suite 330, Independence, OH, 44131, US

(73) Assignee: Ortery Technologies, Inc., Panchiao (TW)

(21) Appl. No.: 12/169,890

(22) Filed: Jul. 9, 2008

(51) Int. Cl. H04N 7/00

(52) U.S. Cl. 348/37; 348/E07.001

(57) ABSTRACT

This invention discloses a method of shooting angle adjustment for as image capture device that moves along a circular path at different locations. The invention comprises two ways to adjust the shooting angle at different locations; one is └Auto Angle Offset┘ and the other is └Shooting Angles' Memory Teaching┘. The invention can ensure those created images used to compose a spherical 3D animation file are all inside the view frame of the shooting area of the pictures, and that means any part of the spherical 3D animation will not be cut off.

### BACKGROUND OF THE INVENTION

1. Field of the Invention

This invention, relates to a method of adjusting shooting angle for an image capture device that moves along a circular path, and in more particularly to a method of a shooting angle compensation.

2. Description of the Prior Art

Even though the digital camera has been used popularly but using computer to control the turntable and a digital camera synchronously is still at beginning. In common practice, it is the number of the pictures selection on the turntable for a 360° rotation rather than directly control on a monitor. Few digital camera manufacturers release the software development kits (SDK), which is capable of controlling the digital camera completely. However none of the system integrators develop the related application software for computer to synchronously control the turntable and the digital camera based on the SDK to automatically take the pictures for a 360° animation, such as the image format of GIF and Flash (SWF).

So far, a method for integrally controlling the turntable, digital camera and move the digital camera along a circular path via a computer to take the pictures from different sheeting angles to create a spherical 3D animation tiles has not been developed. The spherical 3D image is emphatically applied for the laser scan of a physical object to build a 3D model for machining purpose, but it is not very common to display the object with a spherical 3D animation on the website for showing the photographed object's orientation. Further, a method to integrally control the turntable, the digital camera and move the digital camera along a circular path has not been developed. Some SDKs of single lens camera, denoted SLR, only provide the operations of snapping and images transmitting, and only few SDKs of compact digital camera or so called consumer camera have full operations including preview, zoom in/out, aperture, shutter speed, ISO and white balance. The SDKs of SLR does not provide the operations of zoom in/out and SDR has complex adapting of camera lens that will make photography automation become more difficult.

It is possible to cut off some created images of a photographed object if the camera lens collimates to the center of the turntable rather than to the center of the photographed object while the image capture device (such as a digital camera) moves along a circular path for photography. Therefore, it is necessary to adjust shooting angles at different shooting locations to ensure full images of the photographed object can be created.

### SUMMARY OF THE INVENTION

An object of this invention is to adjust the shooting angles for an image capture device that moves along a circular path. The method ensures that the created images of the photographed object will not exceed the view frame of the shooting area of the pictures, and then a full spherical 3D animation can be stitched with the pictures.

Another object of this invention is to provide a method of auto angle offset for a photographer to set the height of a photographed object. The method provides an automatic speedy adjustment of the shooting angles for reducing the possibility of cutting off the created images.

Another object of this invention is to provide a method of memory teaching of the shooting angles. The method ensures that the created images of the photographed object won't be cut off.

Another object of this invention is to make sure the adjustment of the shooting angles at different shooting locations can be confirmed before taking a 360° photography in row sequence automatically.

For better understanding the objects, technologies, features and advantages of this invention, the details of one or more embodiments are set forth in the accompanying drawings and the description below.

### BRIEF DESCRIPTION OF THE DRAWINGS

FIG. 1 is a block diagram illustrating the system control of this invention.

FIG. 2 is a schematic diagram illustrating a method of the memory teaching of the shooting angles of this invention.

FIG. 3 is a schematic diagram illustrating conditions of cutting off the images in absence of adjustment of the shooting angles.

FIG. 4 is a schematic diagram illustrating full images with adjustment of the shooting angles of this invention.

FIG. 5 is a schematic diagram illustrating a method of the auto angle offset of shooting angles of this invention.

FIG. 6 is a flowchart illustrating a method of an auto angle offset of the shooting angles of this invention.

FIG. 7 is a flowchart illustrating a method of a memory teaching of the shooting angles of this invention.

FIG. 8 is a flowchart illustrating the generation of a spherical 3D animation file of this invention.

### DESCRIPTION OF THE PREFERRED EMBODIMENT

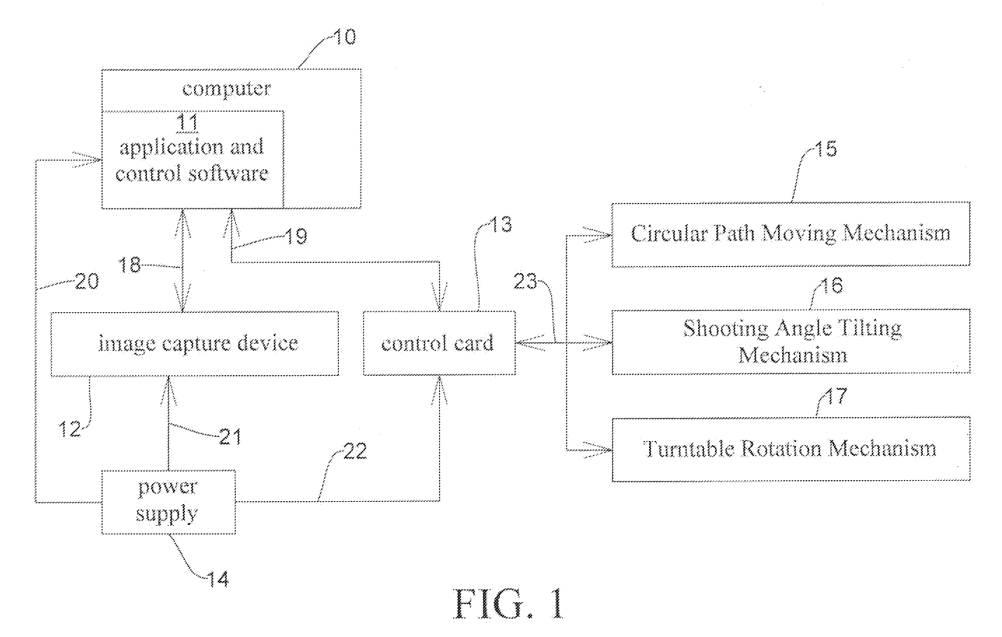

FIG. 1 is a block diagram illustrating the system control according to this invention. It is emphasized to adjust the shooting angles of the shooting angle tilting mechanism 10. The power supply 14 provides a computer 10, an image capture device 12 and a control card 13 with power. The computer 10 connects with the image capture device 12 and the control card 13 via universal serial buses (USBs) 18 & 19, and then the control application software 11 loaded into the computer 10 controls the image capture device 12 and the control card 13. The images created by the image capture device 12 will be sent to the computer 10 via the USB. The circular path moving mechanism 15, the shooting angle tilting mechanism 16 and the turntable rotation mechanism 17 are connected to the control card 13 via power line/signal line 23 for controlling.

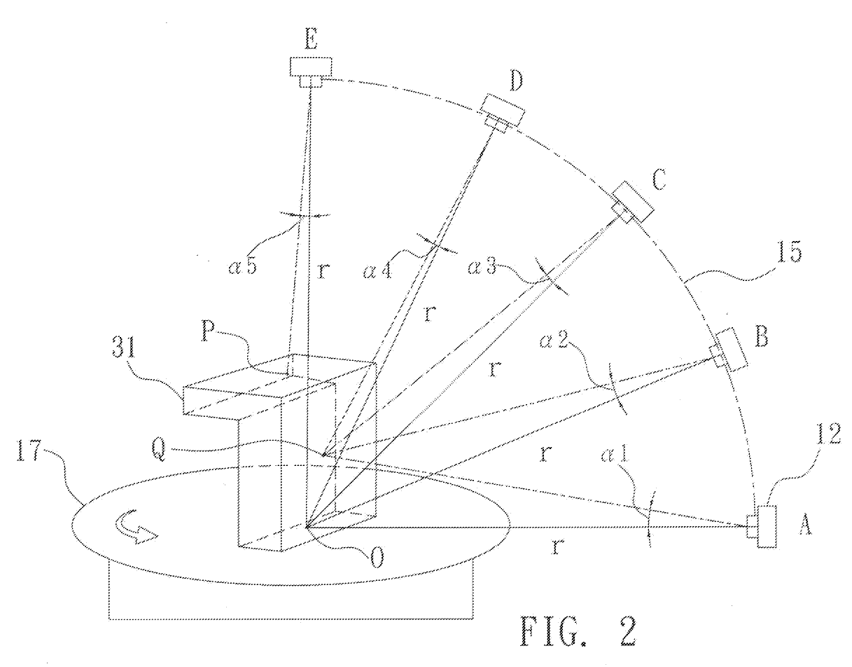

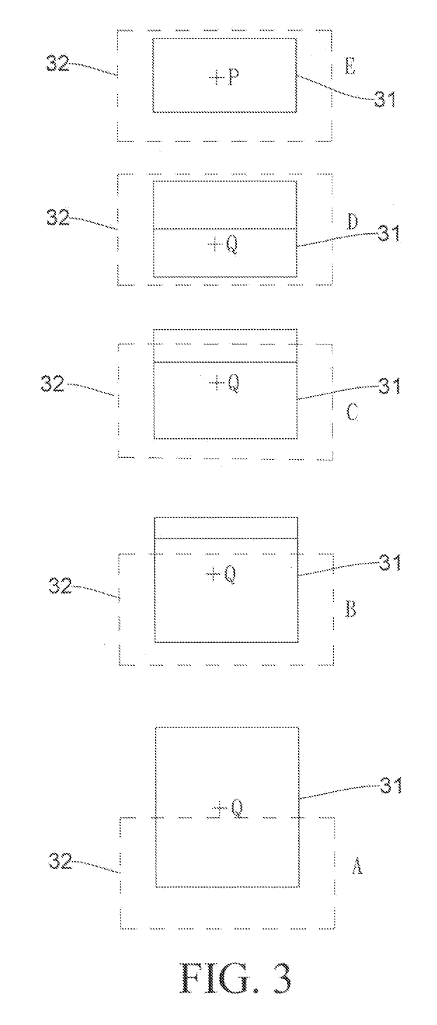

FIG. 2 is a schematic diagram illustrating a method of the memory teaching the shooting angles according to this invention. As illustrated in FIG. 2, O is the center of turntable rotation mechanism 17, and the Q, F are the center of the side and top of the photographed object respectively and a photographed object 31 is set at the center of the turntable 17, and an image capture device 12 driven by a circular path moving mechanism 15 moves along a circular path. Locations A, B, C, D, and E are assumed to be the shooting locations of the Row#1, Row#2, Row#3, Row#4 and Row#5 in this example. At each shooting location that the turntable rotation mechanism 17 needs to rotate a complete 360°. The shooting angles of the image capture device 12 are adjusted by the shooting angle tilting mechanism 16 to ensure the image of the photographed object 31 is completely in the view frame of shooting area 32 as illustrated in FIG. 3.

FIG. 3 is a schematic diagram illustrating the conditions of cutting off the images due to the absence of adjustment of the shooting angles. The image of the photographed object 31 has the worst condition due to the fact that the image is cut off in the view frame of shooting area 32 at horizontal shooting location A, and the images created at locations B and C are also cut off. The image created at location D even not being cut off but still not at the center of the view frame of shooting area 32, and the created image at the top location E still not shown at the middle due to the irregular shape of the photographed object 31. Therefore, it is necessary to adjust the shooting angles for different shooting locations.

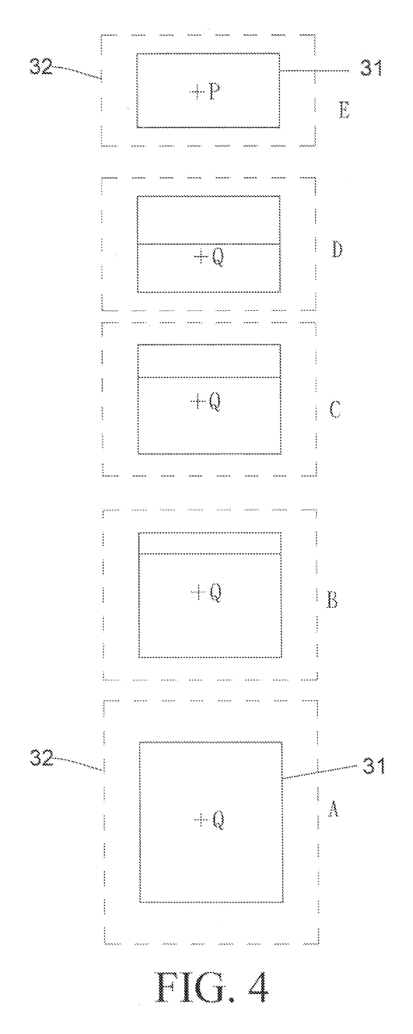

FIG. 4 is a schematic diagram illustrating full images with the adjustment of the shooting angles according to this invention. From the horizontal shooting location A to the top shooting location E, the shooting angles are adjusted at different shooting locations to ensure that the created images of the photographed object 31 are located at the center of the view frame of shooting area 32.

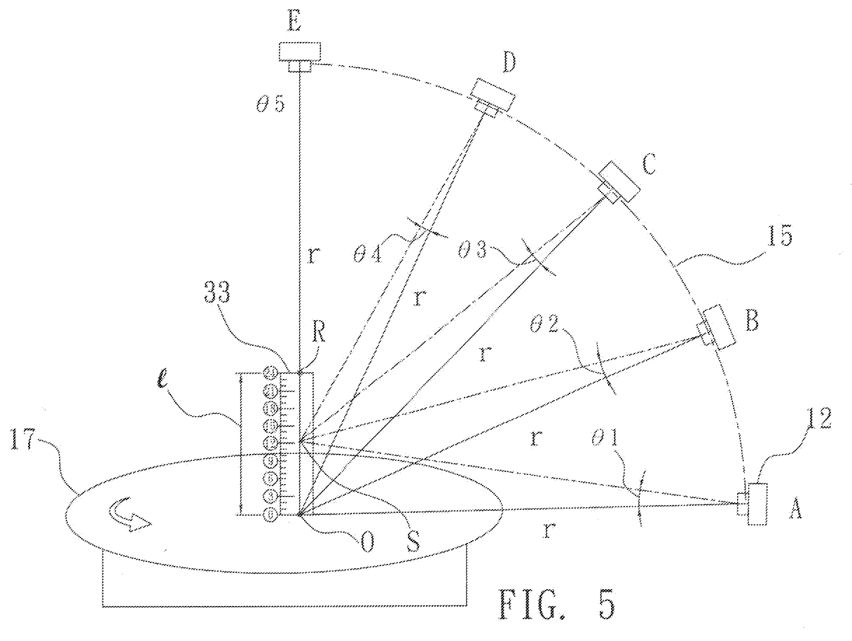

Two ways for shooting angle adjustment at different locations according to this invention are provided, one is Auto Angle Offset as illustrated in FIG. 5 and tire other is Memory Teaching of the shooting angle as illustrated in FIG. 2.

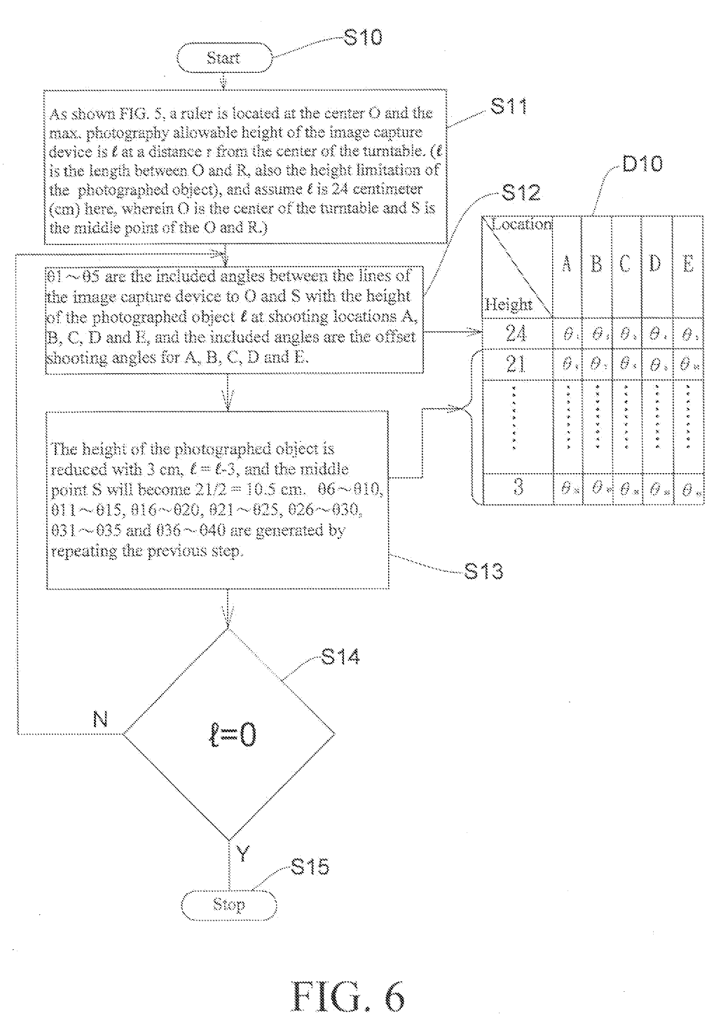

FIG. 5 is a schematic diagram illustrating a method of the auto angle offset of the shooting angles according to this Invention. O is the center of the turntable rotation mechanism 17, and S and R are the middle and top measuring points of the ruler 33 respectively. A flowchart of this method is illustrated in FIG. 6 for illustrating the details. The method starts at step S10. A ruler 33 is located at the center O of the turntable rotation mechanism 17 and the circular path moving mechanism 15 is fixed its moving distance with radius r from the center O of the turntable rotation mechanism 17. In step S11, the max photography allowable height of the Image capture device 12 is determined as l. l is the length between O and R and also the height limitation of the photographed object 31, where l is 24 centimeter (cm) is assumed. S is the middle point of the O and R.

Next, in step S12, the image capture device 12 is driven by the circular path moving mechanism 15 to move to the locations of A, B, C, D and E to determine adjustments of the shooting angles θ1˜θ5 with height l of the photographed object 31. The adjustments of the shooting angles θ1˜θ5 are recorded into a lookup table (LUT) D10 of the auto angle offset. Next, in step S13, the height l of the photographed object 31 or the ruler 33 is reduced by 3 cm, l is equal to 21 cm and the middle point S now becomes 10.5 cm. The previous step is repeated to obtain adjustments of the shooting angles θ6˜θ10 and then recorded into LUT D10 again. The steps S12-S14 are iterated until the stop condition, l=0. As the results, the full adjustments of the shooting angles of θ6˜θ10, θ11˜θ15, θ16˜θ20, θ21˜θ25, θ26˜θ30, θ31˜θ35, θ36˜θ40 for ail shooting locations are all determined and recorded into LUT D10, to end at step S15.

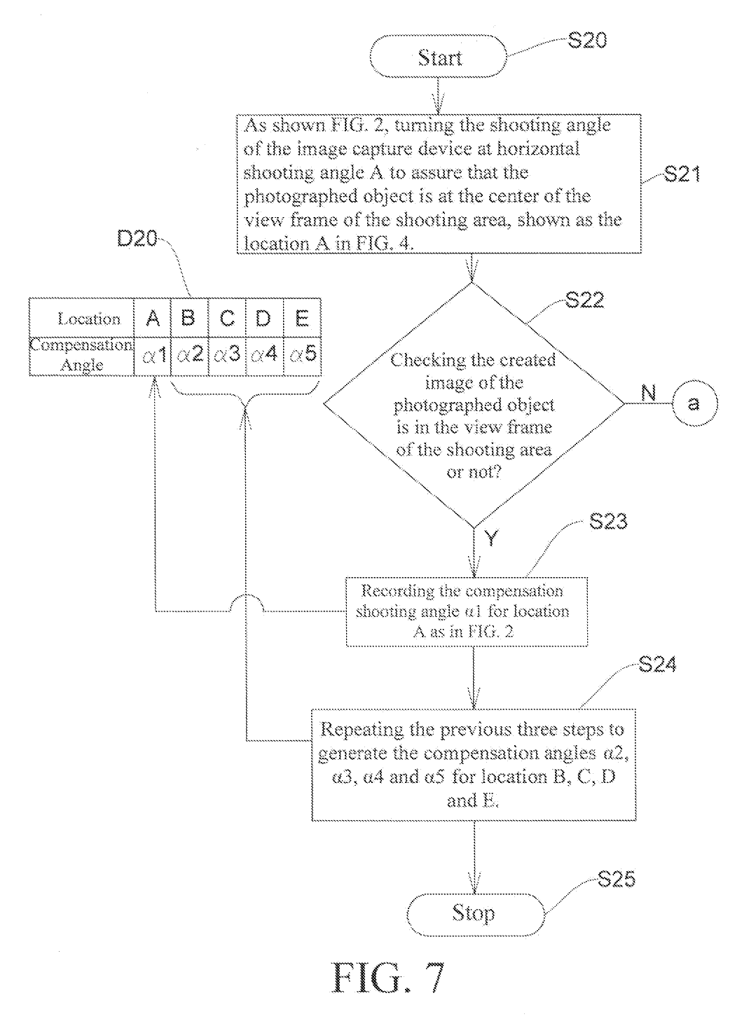

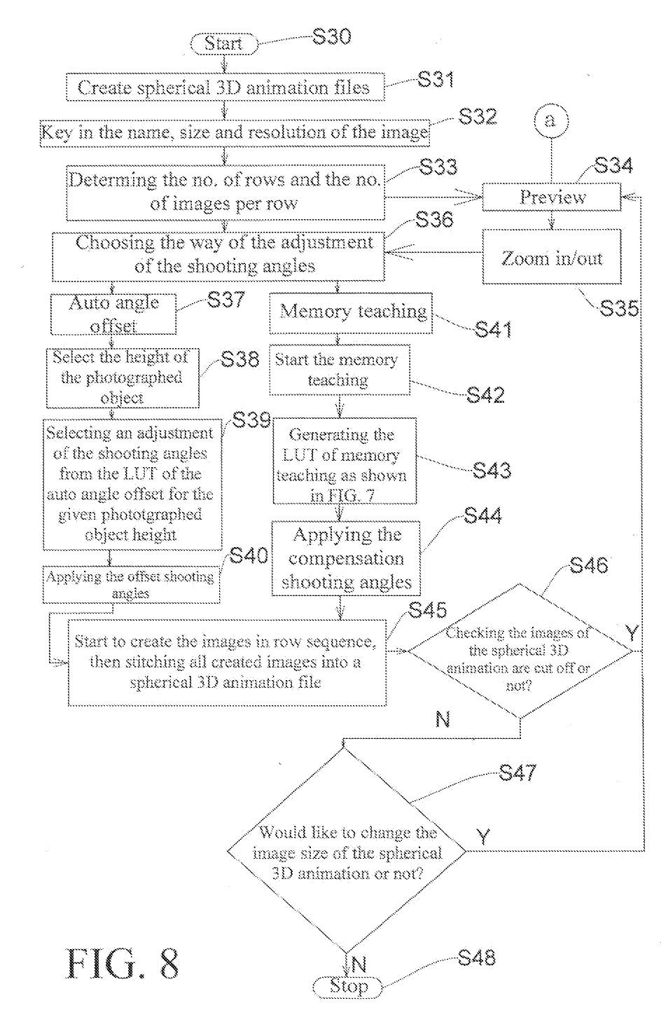

FIG. 7 is a flowchart illustrating the method of the memory teaching of the shooting angles according to this invention. The details of the schematic diagram FIG. 2 Is illustrated as steps S42 and S43 in FIG. 8. First, the method starts from the step S20. Step S21 is to turn the shooting angle of the image capture device 12 at the horizontal shooting location A to ensure that the created image of the photographed object 31 is at the center of the view frame of the shooting area 32 as illustrated by the created image located at A in FIG. 4. Step S22 is to confirm that the created Image of the photographed object 31 is in the view frame of the shooting area 32. If the created image of the photographed object 31 is not in the view frame of the shooting area 32, the flow goes to for connecting to the as illustrated in FIG. 8. After proceeding the step S34 of previewing and step S35 of zooming out, the flow goes back to the step S21 in FIG. 7 to restart. If the image of the photographed object 31 is in the view frame of the shooting area 32, the flow goes to step S23 of recording the compensation shooting angle α1 for the location A as in FIG. 2 Into the LUT D20 of Memory Teaching in step S23. Step S24 is to repeat the previous steps to obtain the adjustments of the shooting angles α2, α3, α4 and α5, which are recorded In LUT D20, for locations B, C, D and E As a result, the full adjustments of the shooting angles for ail shooting location are determined and recorded in LUT D20. Finally, the stop step S25 ends the iteration.

FIG. 8 is a flowchart 1 frustrating the generating of a spherical 3D animation file according to this invention. Step S30 is the start step of this method. Firstly, the step S31 is selected to create a spherical 3D animation file and the step S32 is to key in the image name, image size and image resolution that will be stitched into the spherical 3D animation file. Next, step S33 is to determine the number of rows and the number of images per row, which is the number of pictures that the image capture device 12 will take when moving along the circular path. Continuously the following steps of the preview step S34 and the zooming in/out step S35 are directly controlled on the monitor of the computer 10.

Next, step S36 is to select the way of adjusting the shooting angles.

Once the way of auto angle offset is selected, the flow goes to step S37, and the following step S38 is to select the height of the photographed object 31. Next, according to the selected height of the photographed object 31, the offset shooting angles is selected from the LUX D10 that generated by the way of the auto angle offset illustrated in FIG. 6 In step S39. Then step S40 will apply the offset shooting angle for all different shooting locations.

If the way of the memory teaching is selected, the flow goes to step S41, and the step S42 starts the memory teaching. Then the LUT D20 of the memory teaching is generated in step S43, where the LUT D20 records the compensation shooting angles. Step S44 is to apply the compensation shooting angles for all shooting locations.

Next, step S45 starts to create the images in row sequence and then to stitch all created images into the spherical 3D animation file. The following step S40 is to check that the images of the spherical 3D animation are cut off or not. If the created images of the photographed object are cut off, then the flow goes back to the step S34 to repeat the whole process; if not, the flow goes to step S47 to provide user interface for accepting user's instruction to decide the modification of the image size of the spherical 3D animation. If the instruction is to change the image size, the flow goes back to step S34 to repeat the whole process; if not, the flow goes to the stop step S48 to complete the generation of a spherical 3D animation.

Although this invention has been explained in relation to its preferred embodiment, it is to be understood that modifications and variation can be made without departing the spirit and scope of the invention as claimed.

What is claimed is:

1. A method of shooting angles adjustment for an image capture device that moves along a circular path, comprising:
(1) Controlling a movement and a rotation of said image capture device via a controller;
(2) Choosing the offset shooting angles from an established lookup table for all different shooting locations according to the height of said photographed object for said image capture device that moves along said circular path; and
(3) Applying the offset shooting angles for all different shooting locations of said image capture device on said circular path.

2. The method of shooting angles adjustment for an image capture device that moves along a circular path, according to claim 1, wherein the shooting angles adjustment apply the offset shooting angles to the said image capture device on said circular path in row sequence automatically.

3. The method of shooting angles adjustment for an image capture device that moves along a circular path, according to claim 1, wherein said controller comprises a computer.

4. A method of shooting angles adjustment for an image capture device that moves along a circular path, comprising:
(1) Controlling a movement and a rotation, of said image capture device via a controller;
(2) Generating a lookup table of shooting angles adjustment via a memory teaching to obtain the compensation shooting angles for all different shooting locations for said image capture device that moves along said circular path; and
(3) Applying the compensation shooting angles for all different shooting locations of said Image capture device on said circular path.

5. The method of shooting angles adjustment for an image capture device that moves along a circular path, according to claim 4, wherein the shooting angles adjustment apply the compensation shooting angles to the said image capture device on said circular path in row sequence automatically.

6. The method of shooting angles adjustment for an image capture device that moves along a circular path, according to claim 4, wherein said controller comprises a computer.
